(19) United States
(12) Patent Application Publication
(10) Pub. No.: US 2012/0261520 A1
(43) Pub. Date: Oct. 18, 2012

(54) ARTICULATING YOKE MOUNT

(76) Inventors: Kim C. Groomes, Hartland, MI (US); Craig Earl McClure, Waterford, MI (US)

(21) Appl. No.: 13/489,937

(22) Filed: Jun. 6, 2012

Related U.S. Application Data
(63) Continuation-in-part of application No. 12/564,118, filed on Sep. 22, 2009, now Pat. No. 8,215,583.
(60) Provisional application No. 61/098,816, filed on Sep. 22, 2008.

(51) Int. Cl. F16M 13/00; B23P 11/00; B60R 7/04

(52) U.S. Cl. 244/234; 248/288.11; 248/201; 248/276.1; 29/428

(57) ABSTRACT

An articulating yolk mount includes a first support plate and a second support plate connected relative to the first support plate. The second support plate is rotatable relative to the first support plate.

### CROSS REFERENCE TO RELATED APPLICATIONS

This application is a continuation-in-part of U.S. patent application Ser. No. 12/564,118, filed on Sep. 22, 2009, which claims priority to U.S. Provisional Application No. 61/098,816, which was filed on Sep. 22, 2008.

### BACKGROUND

This disclosure generally relates to an aircraft control yoke assembly, and more particularly to an articulating yoke mount of an aircraft control yoke assembly.

Modern aircraft often include electronic devices, such as tablet devices, electronic flight bags, or similar electronic devices, that aid flight crews in performing flight management tasks more easily and efficiently. Electronic devices of this type are generally computing platforms that store information such as the aircraft operating manual, the aircrew operating manual, and navigational charts, as well as other information that may be accessed by the flight crew during flight.

Yoke mounts are known for mounting electronic devices to the control yokes of the aircraft. Yoke mounts are typically hard mounted (i.e., positioned at a fixed point in space) to the control yokes. That is, once mounted, the mount and the electronic device are immovable.

### SUMMARY

An articulating yolk mount can include a first support plate and a second support plate connected relative to the first support plate. The second support plate is rotatable relative to the first support plate.

In another exemplary embodiment, an aircraft control yoke assembly can include a control yoke and an articulating yoke mount that is mounted to the control yoke. The articulating yoke mount includes a first support plate that is selectively moveable in a first direction relative to the control yoke and a second support plate that is selectively moveable in a second direction relative to the first support plate.

In yet another exemplary embodiment, a method for positioning an articulating yoke mount of an aircraft control yoke assembly includes adjusting a position of a first support plate of the articulating yoke mount in a first direction relative to the aircraft control yoke, and adjusting a position of a second support plate of the articulating yoke mount relative to the first support plate by moving the second support plate in a second direction.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates portions of an aircraft control yoke assembly positioned within an aircraft cockpit.

FIGS. 2A and 2B illustrate an example articulating yoke mount.

FIG. 3 illustrates an example adapter plate for use with the example articulating yoke mount illustrated in FIGS. 2A and 2B.

FIG. 4A illustrates a first position of an example articulating yoke mount.

FIG. 4B illustrates a second position of an example articulating yoke mount.

FIG. 4C illustrates yet another positioning of an example articulating yoke mount.

FIG. 5 illustrates another articulating yoke mount.

FIG. 6 illustrates another aircraft control yoke assembly having an articulating yoke mount.

FIGS. 7A and 7B illustrate the positioning of an electronic device using an articulating yoke mount.

FIG. 8 illustrates a second support plate of an articulating yoke mount.

FIG. 9 illustrates additional features of the second support plate of FIG. 8.

FIGS. 10A and 10B illustrate an adaptor of an articulating yoke mount.

FIG. 11 illustrates an assembly view of a second support plate and an adaptor of an articulating yoke mount.

### DETAILED DESCRIPTION

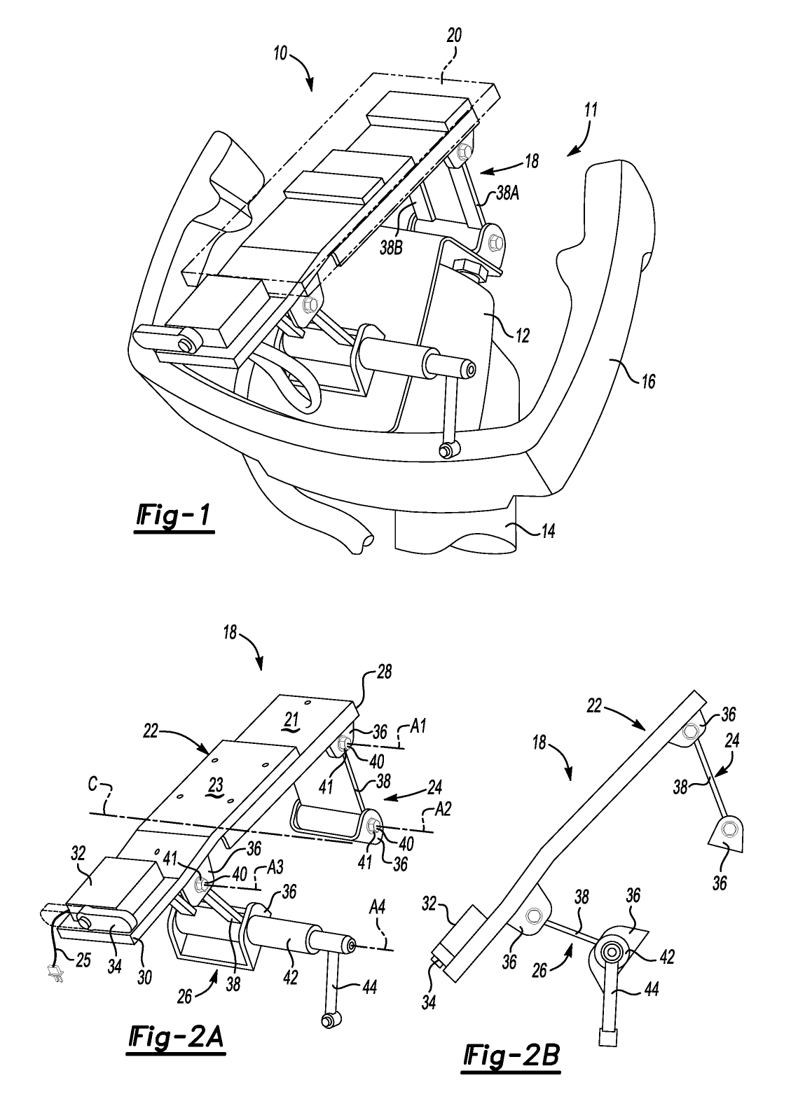

FIG. 1 illustrates portions of an aircraft cockpit 10 that includes an aircraft control yoke assembly 11. As known, an aircraft pilot utilizes a control yoke 12 of the aircraft control yoke assembly 11 to control the altitude of the aircraft. Although only a single control yoke 12 is illustrated, it should be understood that the aircraft cockpit 10 could include multiple aircraft control yokes. The control yoke 12 is generally connected to a control shaft 14 and includes one or more handles 16. The control shaft 14 may include an offset, a central, or any other control shaft configuration. Although a U-shaped handle 16 is illustrated, the handle 16 may take various configurations.

An example articulating yoke mount 18 of the aircraft control yoke assembly 11 is mounted to a portion of the control yoke 12. The articulating yoke mount 18 supports an electronic device 20 for displaying information to an aircraft pilot. In one example, the electronic device 20 includes an electronic flight bag. In another example, the electronic device 20 is an electronic information management device that includes an electronic display unit, such as a tablet PC, for displaying flight information to the aircraft pilot. It should be understood that any electronic device may be mounted by the articulating yoke mount 18. The example articulating yoke mount 18 is adjustable to modify a viewing angle of the electronic device 20 relative to the aircraft pilot, as is further discussed below.

FIGS. 2A and 2B illustrate numerous features of the example articulating yoke mount 18 referenced in FIG. 1. The articulating yoke mount 18 includes a support plate 22, a first bracket assembly 24 and a second bracket assembly 26. The support plate 22, the first bracket assembly 24 and the second bracket assembly 26 are aluminum, in one example. Other materials are contemplated as within the scope of this disclosure, and a worker of ordinary skill in the art would be able to select an appropriate material for these components.

In this example, the first bracket assembly 24 and the second bracket assembly 26 are positioned adjacent opposite ends 28, 30 of the support plate 22. In another example, the first bracket assembly 24 and the second bracket assembly 26 are positioned on opposite sides of a central axis C (FIG. 2A) of the support plate 22. That is, one bracket assembly 24, 26 is positioned on each half of the support plate 22. A worker of ordinary skill in the art would understand that the actual positioning of each bracket assembly 24, 26 could vary depending upon design specific parameters, including but not limited to, the type and configuration of the control yoke 12.

In this example, the support plate 22 includes a first plate piece 21 and a second plate piece 23. The first plate piece 21 and the second plate piece 23 are adjoined in a known manner to configure the support plate 22. Although the support plate 22 is illustrated as having two plate pieces, it should be understood that the support plate 22 may be comprised of a single plate piece (See FIG. 2B), or any number of plate pieces.

The support plate 22 includes a support ledge 32 positioned at the end 30 of the support plate 22. The support ledge 32 receives and supports the electronic device 20. In one example, the support plate 22 includes an electrical connector 25 for electrically connecting the electronic device 20 to the support plate 22. The electronic device 20 engages the support ledge 32 to electrically connect the components.

The support ledge 32 further includes a locking arm 34. The locking arm 34 is rotatable between a first position (shown in solid lines) and a second position (shown in phantom lines) to lock and unlock the electronic device 20 relative to the support plate 32. Although illustrated with a locking arm 34, it should be understood that the other locking mechanisms are contemplated as within the scope of this disclosure for removeably securing the electronic device 20 relative to the support plate 22 of the articulating yoke mount 18.

In this example, the first bracket assembly 24 and the second bracket assembly 26 include the same general design except where indicated otherwise. Each of the first bracket assembly 24 and the second bracket assembly 26 includes a pair of linkage brackets 36 and at least one linkage arm 38 that extends between each pair of linkage brackets 36. In this example, each linkage arm 38 is connected to each linkage bracket 36 via fasteners 40. The fasteners 40 are bolts secured with a nut 41, in one example.

The linkage brackets 36 each define a pivot axis A1, A2, A3 and A4, respectively. The pivot axes A1, A2, A3 and A4 extend along a longitudinal axis of the linkage bracket 36, and in this example extend along a longitudinal axis of each fastener 40. Therefore, the example articulating yoke mount 18 (and more particularly the linkage arms 38) is pivotable about each of the pivot axes A1 through A4 to position the electronic device 20 at a desired angle and positioning relative to the aircraft pilot. That is, in this example, the articulating yoke mount 18 is pivotable about each of four different axes. Rotation of the linkage arms 38 of the first bracket assembly 24 and the second bracket assembly 26 enables positioning of the support plate 22 (and therefore the electronic device 20) at a desired viewing angle relative to the aircraft pilot. In one example, the articulating yoke mount 18 provides approximately 180° of freedom for each linkage arm 38 to pivot about its respective pivot axes A1, A2, A3 and A4.

In the illustrated example, the linkage arms 38 are a single-piece arm. In another example, each linkage arm 38 includes a first arm linkage 38A and a second arm linkage 38B (See FIG. 1). Other designs are also contemplated as within the scope of this disclosure, including multi-link arms, or any other linkage configuration. The actual design of the linkage arms 38 will vary depending upon design specific parameters, including but not limited to, the type and configuration of the control yoke 12.

The second bracket assembly 26 includes a friction lock 42, in this example. In a locked position, the friction lock 42 prevents rotation of the linkage arms 38 about the pivot axes A3 and A4. Therefore, once locked, the articulating yoke mount 18 positions the electronic device 20 at a desired position. The friction lock 42 may be manually released by rotating a locking arm 44 of the friction lock 42. Alternatively, the first bracket assembly 24 could include the friction lock 42, or both the first bracket assembly 24 and the second bracket assembly 26 could include a friction lock 42.

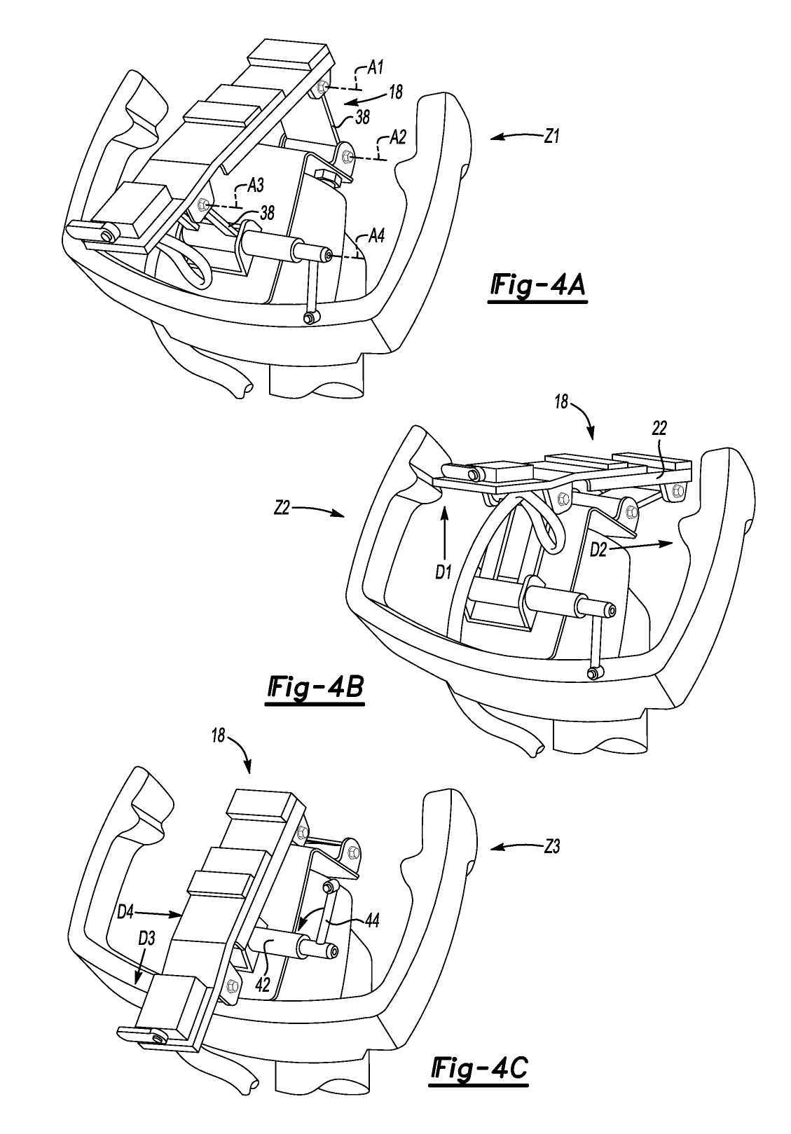

Moreover, the friction lock 42 includes an override feature. In one example, the friction lock 42 is unlocked in response to overcoming a friction force generated by the friction lock 42 to allow rotation of the linkage arms 38 about axes A3 and A4. In this way, the support plate 22 is collapsible. For example, the aircraft pilot may generate a force with his/her hand by pushing on the support plate 22 of the articulating yoke mount 18 in a direction D4 (toward the control yoke 12) that is transverse to the support plate 22 (See FIG. 4C). Although illustrated as a friction lock, it should be understood that other locking devices for releaseably locking the articulating yoke mount 18 are contemplated as within the scope of this disclosure. The friction lock 42 eliminates the necessity of hard mounting the support plate 22.

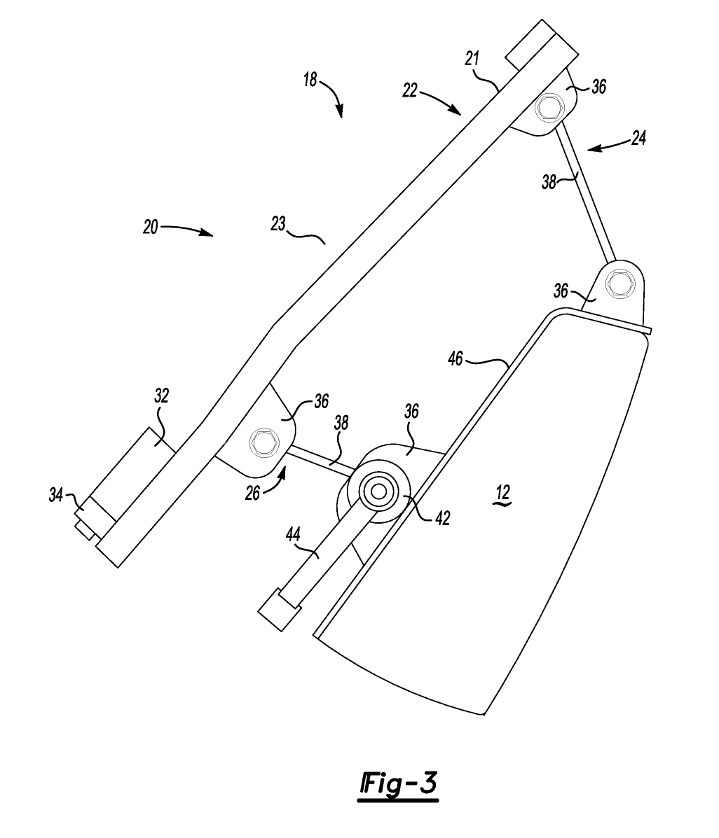

The example articulating yoke mount 18 is a universal mount. That is, the articulating yoke mount 18 is mountable in any aircraft having any type of control yoke 12. To accomplish this, as illustrated in FIG. 3, the articulating yoke mount 18 includes an adapter plate 46 for mounting the articulating yoke mount 18 in a particular aircraft cockpit. The adapter plate 46 is positioned between the control yoke 12 and the articulating yoke mount 18. The size, shape and configuration of the adapter plate 46 could vary depending upon the type of control yoke 12 disposed within the aircraft, and this disclosure is not limited to an adapter plate having the specific design shown in FIG. 3.

For example, one linkage bracket 36 of each of the first bracket assembly 24 and the second bracket assembly 26 is mounted to the adapter plate 46 in a known manner at a desired position of the adapter plate 46 to accommodate a particular control yoke 12 design. The actual positioning of the first bracket assembly 24 and the second bracket assembly 26 relative to the adapter plate 46 will vary depending upon design parameters, including but not limited to, the type of control yoke 12 the articulating yoke mount 18 is mounted to. The adapter plate 46 is next mounted to the control yoke 12 in a known manner. Therefore, the example articulating yoke mount 18 is mountable within any known aircraft cockpit.

FIG. 4A illustrates a first example positioning Z1 of the articulating yoke mount 18. In this example, the positioning Z1 is a viewing position. The aircraft pilot positions the articulating yoke mount 18 at a desired position by rotating the linkage arms 38 about the pivot axes A1, A2, A3 and A4 to position the electronic device 20 at a desired viewing angle relative to the aircraft pilot. In this example, the position Z1 is used during normal flight operation.

FIG. 4B illustrates another example position Z2 of the articulating yoke mount 18. In this example, the articulating yoke mount 18 is positioned at a full up and over position, or ingress/egress position. That is, the articulating yoke mount 18 is positioned at the Z2 position shown in FIG. 4B to facilitate entrance/exit to/from the aircraft pilot chair by the aircraft pilot. The support plate 22 is moveable generally in a first direction D1 (i.e., generally transverse to the support plate 22) and a second direction D2 (i.e., generally parallel to the support plate 22) to position the articulating yoke mount 18 in the ingress/egress position Z2.

FIG. 4C illustrates yet another example positioning Z3 of the articulating yoke mount 18. In this example, the position Z3 represents a collapsed position. A collapsed position may be required during takeoff and/or landing, for example. In another example, the collapsed position is required during extreme maneuvering of the aircraft. The articulating yoke mount 18 is easily collapsed by overcoming the force of the friction lock 42. The friction force of the friction lock 42 is overcome by communicating a force that is transverse to the support plate 22 (i.e., in the direction D4).

In another example, the collapsed position is achieved by rotating the locking arm 44 of the friction lock 42 and pulling on the support plate 22 generally in a direction D3 (i.e., parallel to the support plate 22). The linkage arms 38 of the first bracket assembly 24 and the second bracket assembly 26 rotate about the pivot axes A1, A2, A3 and A4 to position the articulating yoke mount 18 in the collapsed position.

Although only three positions Z1 through Z3 are illustrated, it should be understood that the articulating yoke mount 18 is adjustable to accommodate any desired viewing angle of the aircraft pilot. The example articulating yoke mount 18 is adjustable over a range between approximately 0° (as depicted in FIG. 4C) and 90° (as depicted in FIG. 4B) relative to the control yoke 12, in this example. Exceptional readability of the electronic device 20 in all cockpit ambient light conditions is therefore provided by the articulating yoke mount 18.

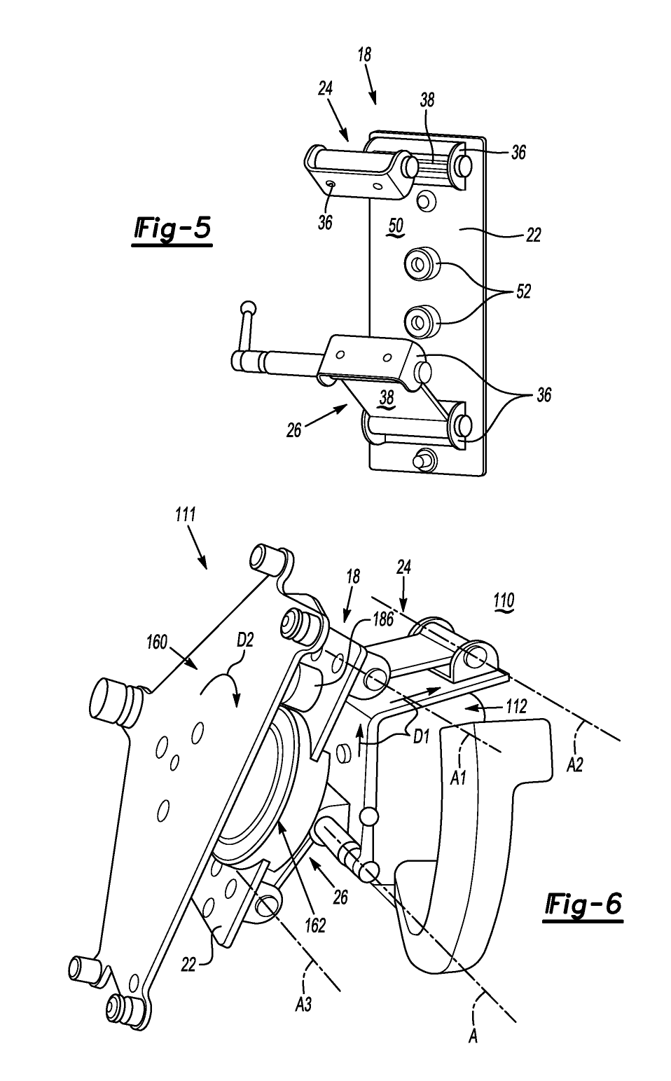

FIG. 5 illustrates additional features that can be incorporated into the articulating yoke mount 18. A rear face 50 of the support plate 22 can include one or more bumpers 52 that can soften the contact between the support plate 22 and the first bracket assembly 24 and/or the second bracket assembly 26. For example, during movement between the positions Z1, Z2 and Z3 (See FIGS. 4A-4C), portions of the first bracket assembly 24 and the second bracket assembly 26 (such as the linkage brackets 36 and/or the linkage arms 38) can contact the support plate 22. The bumpers 52 cushion any impact between the first bracket assembly 24 and the second bracket assembly 26 relative to the support plate 22. In one exemplary embodiment, the bumpers 52 are spring loaded rubber bumpers, although other designs and configurations are contemplated as within the scope of this disclosure.

FIG. 6 illustrates another exemplary aircraft control yoke assembly 111 that can be incorporated into an aircraft cockpit 110. In this disclosure, like reference numerals signify like features, whereas reference numerals in multiples of ‘100’ signify modified features. The aircraft control yoke assembly 111 includes a control yoke 112 and an articulating yoke mount 118 that is mounted to the control yoke 112.

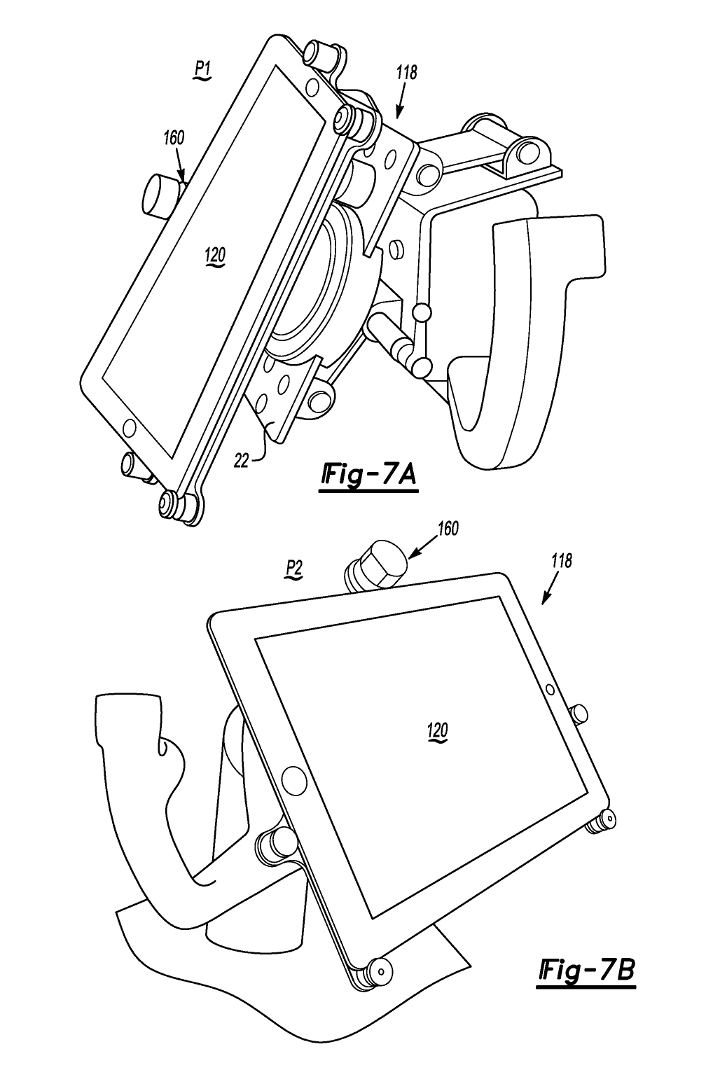

The articulating yoke mount 118 can support an electronic device 120 (See FIGS. 7A and 7B) for displaying information to an aircraft pilot. In one exemplary embodiment, the electronic device 120 is an iPad or other tablet type electronic device. It should be understood that any electronic device may be supported by the articulating yoke mount 118 for viewing by an aircraft pilot. The articulating yoke mount 118 is selectively adjustable to modify a viewing angle and positioning of the electronic device 120 relative to the aircraft pilot, as is further discussed below.

In this exemplary embodiment, the articulating yoke mount 118 includes a first support plate 22, a first bracket assembly 24 and second bracket assembly 26 that are substantially similar to like features of the articulating yoke mount 18 illustrated in FIGS. 1-4. The articulating yoke mount 118 can further include a second support plate 160 that is connected for rotational movement relative to the first support plate 22. For example, as discussed above and shown with respect to FIGS. 1-4, the first support plate 22 can be selectively moved in a first direction D1 (that is generally parallel or transverse to the first support plate 22) to pivot the first support plate 22 about the pivot axes A1, A2, A3 and A4 and position the first support plate 22 relative to the control yoke 112. It should be understood that the first support plate 22 can be adjusted to accommodate any desired viewing angle of the aircraft pilot (See FIGS. 4A-4C, for example).

Once the first support plate 22 is positioned as desired, the second support plate 160 can then be moved in a second direction D2 (that is different from the first direction D1) relative to the first support plate 22 to position the electronic device 120 at a desired position relative to the aircraft pilot (See FIGS. 7A and 7B). In one exemplary embodiment, the second direction D2 is a circumferential direction. The second support plate 160 is rotatable relative to the first support plate 22 via an adaptor 162 that mounts the second support plate 160 to the first support plate 22.

FIGS. 7A and 7B illustrate exemplary positions P1 (FIG. 7A) and P2 (FIG. 7B) of the articulating yoke mount 118 that can be achieved by rotating the second support plate 160 relative to the first support plate 22. In FIG. 7A, the second support plate 160 is positioned relative to the first support plate 22 such that the electronic device 120 is in a portrait position P1. The second support plate 160 can be rotated in either a clockwise or a counterclockwise direction (over a range of 360 degrees) to position the electronic device 120 in a landscape position P2, or vice versa (i.e., from the landscape position P2 to the portrait position P1). The second support plate 160 can be rotated relative to the first support plate 22 to position the electronic device 120 at any position relative to the aircraft pilot, including positions between the positions P1 and P2.

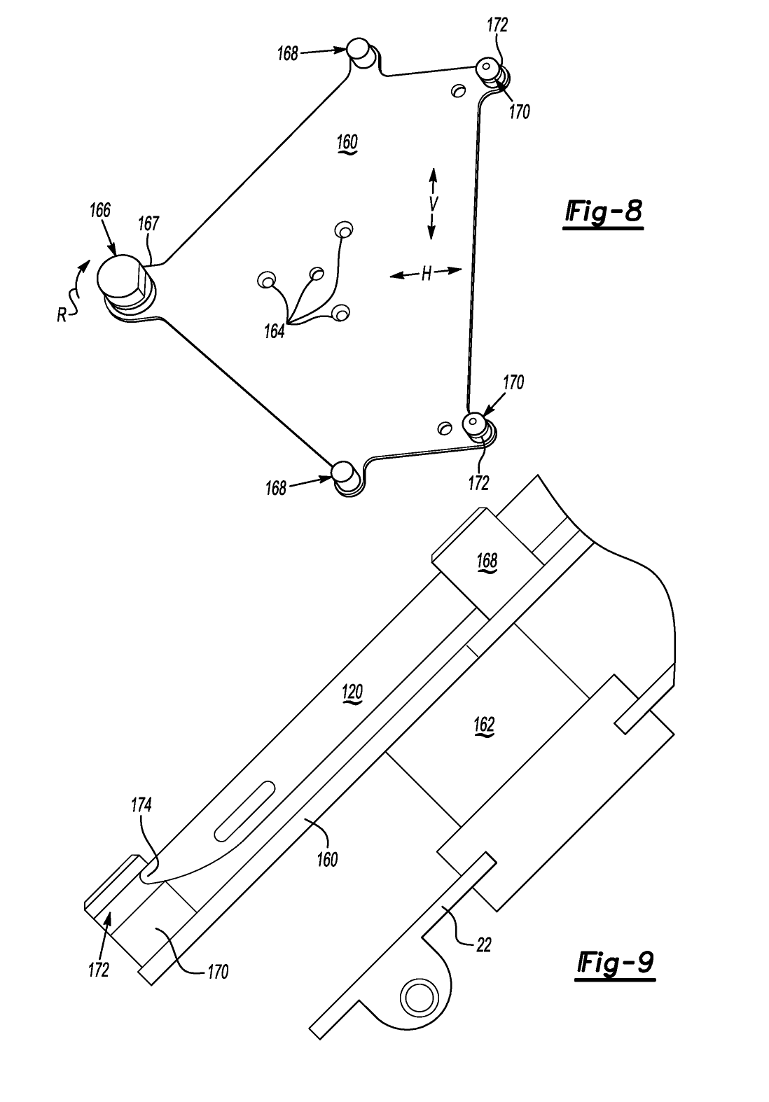

The second support plate 160 is illustrated by FIG. 8. The second support plate 160 can include a plurality of openings 164 for attaching the second support plate 160 to the adaptor 162 (See FIGS. 6 and 11). The second support plate 160 can further include a knob 166, guide pins 168 and pinch pins 170. The knob 166, guide pins 168 and pinch pins 170 position and support the electronic device 120 relative to the second support plate 160 (See FIGS. 7A and 7B, for example). The knob 166 can be rotated in a direction R to lock the electronic device 120 in place relative to the second support plate 160. The knob 166 can be mounted off-center relative to an arm portion 167 of the second support plate 160 so that, once rotated, the knob 166 tightens against the electronic device 120 to lock the electronic device 120 relative to the second support plate 160. The guide pins 168 and pinch pins 170 maintain a horizontal positioning H and a vertical positioning V of the electronic device 120 relative to the second support plate 160.

In one exemplary embodiment, the pinch pins 170 include a slot 172. The slots 172 of each pinch pin 170 can receive an edge 174 of the electronic device 120 (See FIG. 9) to position the electronic device 120 relative to the second support plate 160 once the knob 166 is rotated in the direction R. Although illustrated having a specific configuration in FIG. 8, it should be understood that the second support plate 160 cold embody any size, shape, design and/or configuration. For example, the second support plate 160 could include additional knobs, guide pins or pinch pins than are shown by FIG. 8. The actual design, configuration and shape of the second support plate 160 can vary depending upon design specific parameters, including but not limited to, the size and shape of the electronic device 120 that is supported by the articulating yoke mount 118.

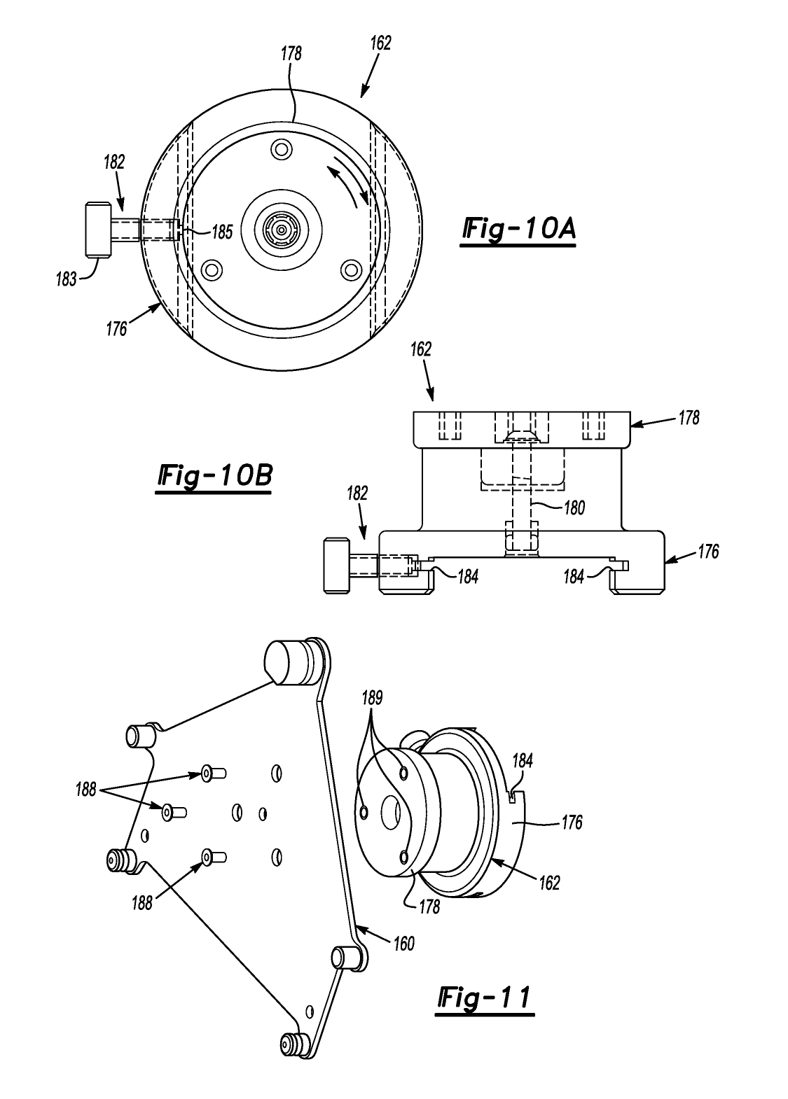

FIGS. 10A and 10B illustrate an adaptor 162 of the articulating yoke mount 118. The adaptor 162 includes a base 176 and a swivel 178 that is mounted to the base 176. The swivel 178 can be mounted to the base 176 via a fastener 180. The swivel 178 is rotatable relative to the base 176 such that when the second support plate 160 is mounted to the swivel 178, the second support plate 160 can be rotated relative to the first support plate 122 to achieve a desired positioning of the electronic device 120. The second support plate 160 is rotatable relative to the first support plate 22 over a range of 360° via the swivel 178. In other words, the swivel 178 can be rotated over a range of 360° relative to the base 176.

The base 176 of the adaptor 162 can include a locking mechanism 182. The locking mechanism 182 can be actuated to prevent movement of the adaptor 162 relative to the first support plate 22. In one exemplary embodiment, the locking mechanism 182 is a lock screw that is actuated by turning a knob 183 in order to engage a set screw 185 relative to the first support plate 22. However, other locking mechanisms are also contemplated as within the scope of this disclosure.

The base 176 can also include slots 184 that establish openings for receiving the first support plate 22. The adaptor 162 is slideable along a length of the first support plate 22 via the slots 184 to position the adaptor 162 along the length of the first support plate 22 (See FIG. 6). The first support plate 22 can include a stop 186 that controls the distance the adaptor 162 is permitted to slide along the length of the first support plate 22 (See FIG. 6). In this exemplary embodiment, the stop 186 includes a rubber bumper.

FIG. 11 illustrates an assembly view of the second support plate 160 and the adaptor 162. The second support plate 160 can be mounted to the swivel 178 of the adaptor 162 via a plurality of fasteners 188 that are received in a plurality of openings 189 of the swivel 178. The second support plate 160 can rotationally support the electronic device 120 once connected to the adaptor 162 and the adaptor 162 is attached to the first support plate 22.

Although the different non-limiting embodiments are illustrated as having specific components, the embodiments of the disclosure are not limited to those particular combinations. It is possible to use some of the components or features from any of the non-limited embodiments in combination with features or components from any of the other non-limiting embodiments.

It should be understood that like reference numerals identify corresponding or similar elements in the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would recognize that various modifications could come within the scope of this disclosure. For these reasons, the following claims should be studied to determine the true scope and content of this disclosure.

What is claimed is:

1. An articulating yoke mount, comprising:
a first support plate; and
a second support plate connected relative to said first support plate, wherein said second support plate is rotatable relative to said first support plate.

2. The mount as recited in claim 1, comprising at least one bracket assembly mounted to said first support plate, wherein a positioning of said first support plate is selectively adjustable relative to said at least one bracket assembly to position said first support plate at a desired viewing angle.

3. The mount as recited in claim 2, wherein said at least one bracket assembly includes a first bracket assembly and a second bracket assembly.

4. The mount as recited in claim 2, wherein said at least one bracket assembly includes a first linkage bracket, a second linkage bracket and at least one linkage arm, and said first linkage bracket defines a first pivot axis and said second linkage bracket defines a second pivot axis, wherein said at least one linkage arm is pivotable about said first pivot axis and said second pivot axis to position said first support plate at said desired viewing angle.

5. The mount as recited in claim 1, wherein a rear face of said first support plate includes at least one bumper.

6. The mount as recited in claim 1, comprising an adapter that mounts said second support plate to said first support plate.

7. The mount as recited in claim 6, wherein said adapter includes a base and a swivel.

8. The mount as recited in claim 7, wherein said base includes slots that receive said first support plate.

9. The mount as recited in claim 1, wherein said adapter is slideable along a length of said first support plate.

10. The mount as recited in claim 1, wherein said second support plate includes at least one pinch pin and at least one guide pin.

11. The mount as recited in claim 1, wherein said second support plate is rotatable relative to said first support plate over a range of 360 degrees.

12. An aircraft control yoke assembly, comprising:
a control yoke; and
an articulating yoke mount mounted to said control yoke, wherein said articulating yoke mount includes a first support plate that is selectively moveable in a first direction relative to said control yoke and a second support plate that is movable in a second direction relative to said first support plate.

13. The assembly as recited in claim 12, wherein said second direction is different from said first direction.

14. The assembly as recited in claim 12, wherein said first support plate is selectively adjustable in said first direction over a range of approximately 90 degrees relative to said control yoke to position said first support plate at a desired viewing angle.

15. The assembly as recited in claim 14, wherein said first support plate is adjustable over said range by pivoting about at least one bracket assembly.

16. The assembly as recited in claim 12, comprising an electronic device supported by said second support plate.

17. The assembly as recited in claim 12, comprising an adapter mounted between said first support plate and said second support plate, wherein said adapter includes a swivel and said second support plate is rotatable relative to said first support plate via said swivel.

18. A method for positioning an articulating yoke mount of an aircraft control yoke assembly, comprising the steps of:
adjusting a position of a first support plate of the articulating yoke mount in a first direction relative to the aircraft control yoke; and
adjusting a position of a second support plate of the articulating yoke mount relative to the first support plate by moving the second support plate in a second direction.

19. The method as recited in claim 18, wherein the first direction and the second direction are different directions.

20. The method as recited in claim 18, wherein the step of adjusting the position of the second support plate includes rotating the second support plate relative to the first support plate.
